(19) United States
(12) Patent Application Publication
(10) Pub. No.: US 2019/0176808 A1
(43) Pub. Date: Jun. 13, 2019

(54) METHOD AND DEVICE FOR STARTING A MOTOR VEHICLE WITH A HYBRID DRIVE

(71) Applicant: ZF Friedrichshafen AG, Friedrichshafen (DE)

(72) Inventors: Rayk GERSTEN, Friedrichshafen (DE); Stefan RENNER, Bodman-Ludwigshafen (DE); Johannes KALTENBACH, Friedrichshafen (DE); Johannes GLÜCKLER, Friedrichshafen (DE)

(21) Appl. No.: 16/324,612

(22) PCT Filed: Jul. 13, 2017
(86) PCT No.: PCT/EP2017/067686

§ 371 Date: Feb. 11, 2019

(30) Foreign Application Priority Data
Aug. 15, 2016 (DE) 10 2016 215 170.3

(51) Int. Cl. B60W 20/30; B60K 6/26; B60K 6/547; B60W 10/06; B60W 10/08; B60W 10/115; B60W 20/40

(52) U.S. Cl. CPC B60W 20/30; B60K 6/26; B60K 6/547; B60W 10/06; B60W 10/08; B60W 10/115; B60K 6/365; B60Y 2200/92; B60Y 2300/192; B60W 2510/244; B60K 2006/268; B60W 2710/1005; B60W 2530/16; B60W 20/40

(57) ABSTRACT

A method for starting a motor vehicle having a hybrid drive including an internal combustion engine and an electric machine (EM). The motor vehicle has a transmission arrangement with which starting can be carried out electro-dynamically or purely electrically. According to the method, a driving resistance of the motor vehicle and a storage condition of an electrical energy storage device of the electric machine (EM) are evaluated and, depending on the evaluated driving resistance and the evaluated storage condition, selecting a desired starting strategy.

This application is a National Stage completion of PCT/EP2017/067686 filed Jul. 13, 2017, which claims priority from German patent application serial no. 10 2016 215 170.3 filed Aug. 15, 2016.

### FIELD OF THE INVENTION

The invention relates to a method for starting a motor vehicle with a hybrid drive, and a corresponding control unit.

### BACKGROUND OF THE INVENTION

From the prior art various possibilities are known for starting a vehicle with a hybrid drive. For example DE 10 2010 063 582 A1 by the present applicant discloses a device for a drive-train of a hybrid vehicle having a planetary gearset arranged between an electric machine and the input shafts of a transmission, and with which a third element of the planetary gearset can be connected to the housing for purely electric starting. This takes place with marked discharging of an electrical energy storage device. During this a high starting torque can be provided by means of the planetary gearset which acts as a constant gear ratio. The third element of the planetary gearset can also be connected to the input shaft of the internal combustion engine, so allowing electro-dynamic starting. In that case the electric machine is operated in generator mode in order more effectively to charge an electrical energy storage device.

The shifting strategy for starting takes into account only the storage condition of the electrical energy storage device. However, starting in the two known starting modes, namely purely electric and electro-dynamic, is affected by other influencing factors as well, which influence the choice of the starting strategy among the two starting options.

### SUMMARY OF THE INVENTION

Accordingly, the purpose of the present invention is to take account of further influencing factors and to improve a shifting strategy for starting within the known starting possibilities.

According to the invention this objective is achieved by the characteristics specified in the independent claims. Further advantageous embodiments are defined in the associated subordinate claims.

The objective is achieved by a method for starting a motor vehicle with a hybrid drive comprising an internal combustion engine and an electric machine, wherein the motor vehicle has an appropriate transmission arrangement with which starting can be carried out electro-dynamically, in the EDA mode, or purely electrically, in the ISG mode, so that a driving resistance of the motor vehicle and a charging condition of the electrical energy storage device of the electric machine are assessed and a starting strategy is chosen depending on the driving resistance and the storage condition recognized.

In choosing a starting strategy, first a starting mode, the ISG mode or the EDA mode is selected. For this the selection depends on the condition of the storage device. The ISG mode for purely electrical starting is chosen when the energy in the electrical energy storage device is sufficient for the starting process planned. The EDA mode for electro-dynamic starting is chosen if the energy in the electrical energy storage device is not sufficient for the starting process planned.

In choosing the starting strategy, after the starting mode has been chosen a starting gear is selected. This is selected as a function of the driving resistance. With increasing driving resistance a lower starting gear is chosen. The lower the driving resistance in the two modes, the higher can be the starting gear and the follow-up gear selected. The loading of the vehicle too has consequences for the starting process and can therefore be taken into account by the control system. With increasing load weight, a lower starting gear is chosen.

Having evaluated, predicted and determined or calculated the condition of the storage device, recognition of the driving resistance determines the decision for choosing the starting mode EDA or ISG. If it is recognized that the energy level in the electrical energy storage device is sufficient, then starting is carried out in the purely electric ISG mode. If in parallel a higher driving resistance is recognized, then as the starting gear the first purely electric gear is selected. In that case the internal combustion engine can be switched off, or idling. Driving continues in the starting gear selected at least until the idling speed of the internal combustion engine in the starting gear selected is reached. The internal combustion engine can then be started while maintaining the electrical load and by closing a shifting element an internal combustion engine sub-transmission can be coupled in. Thereafter the ISG mode can be changed to the EDA mode and thus a shift into the subsequent gear can be carried out electro-dynamically. Depending on the driving resistance recognized and also the loading and the evaluation of the forecast, starting can also be carried out in another purely electric gear available or a shift can be carried out to a direct gear or to a higher subsequent gear.

If it is recognized that the energy level in the electrical energy storage device is not sufficient, starting is carried out purely in the EDA mode. If a large driving resistance is recognized, the first gear in the electric motor sub-transmission is engaged, in which starting can be carried out electro-dynamically. The internal combustion engine and the electric machine carry out the starting process conjointly until synchronization in the first electric motor gear is achieved and the first internal combustion engine gear can be engaged. Depending on the driving resistance and also the loading and evaluation of the forecast, starting in another available electro-dynamic gear or a shift to a direct gear or a higher subsequent gear can also be carried out.

Furthermore a control unit according to the invention, in particular a transmission control unit for operating a drive-train of a motor vehicle with a hybrid drive is proposed, which comprises means for carrying out the method according to the invention.

### BRIEF DESCRIPTION OF THE DRAWINGS

Below, the invention is described in greater detail with reference to an example embodiment:

FIG. 1: An example of a gear layout for carrying out a method according to the invention

FIG. 2: Diagram for selecting the starting mode

FIG. 3: Flow chart of a method according to the invention in the ISG mode

FIG. 4: Flow chart of a method according to the invention in the EDA mode

### DETAILED DESCRIPTION OF THE PREFERRED EMBODIMENTS

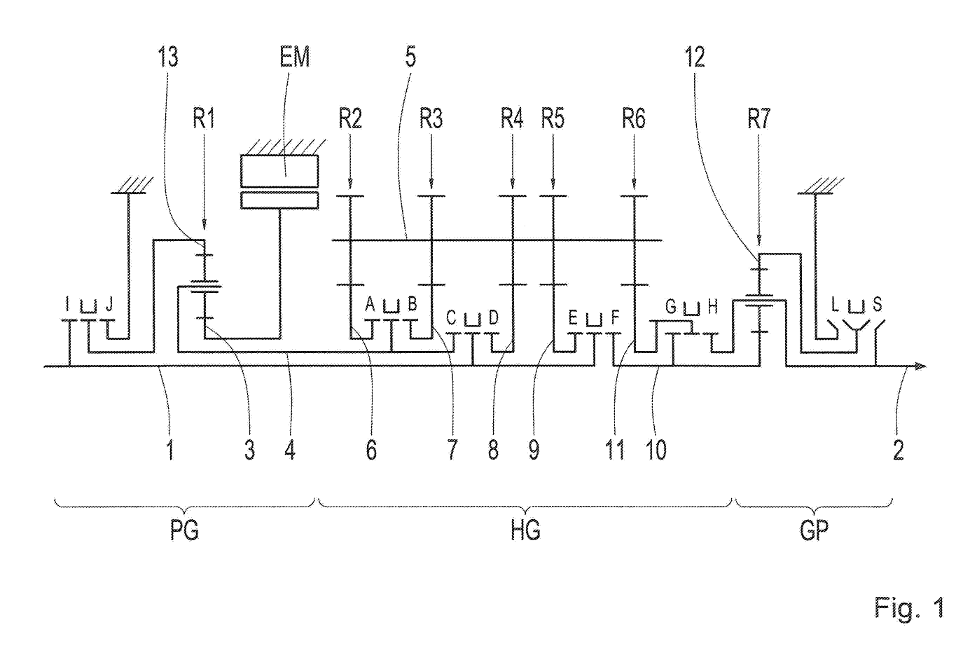

The present gear layout as illustrated in FIG. 1 comprises a first driveshaft 1 for connecting a first sub-transmission of the main transmission HG to a first drive input, in this case an internal combustion engine (not shown), a second driveshaft 4 for connecting a second drive input, in this case an electric machine EM, to a second sub-transmission of the main transmission HG, a countershaft 5, a main shaft 10 and a drive output shaft 2. On the driveshafts 1 and 4 and on the main shaft 10 are mounted five loose wheels 6, 7, 8, 9 and 11, which by means of the shifting elements A, B, C, D, E, F, G and H can be connected to the transmission shafts or a range group GP. The range group GP is formed by a planetary gearset having at least a sun gear, a carrier with planetary wheels and a ring gear 12. The ring gear 12 can be connected by further shifting elements L and S either to a component fixed to the housing or to the drive output shaft 2. The electric machine EM is connected by way of a planetary stage PG to the second sub-transmission of the main transmission HG, wherein it is connected directly to the sun gear 3 of the planetary stage PG. The planetary stage PG is in the form of a classical planetary gearset comprising at least a sun gear 3, a carrier with planetary wheels and a ring gear 13. By means of two shifting elements I and J the ring gear 13 can be connected either to a component fixed to the housing or to the first driveshaft 1. The shifting elements A to J are in the form of unsynchronized claw shifting elements. The shifting elements A to J are designed as shifting units that act on two sides, each of which is shown in its neutral position. The shifting elements L and S of the range group GP are in the form of synchronized shifting elements. The loose wheels 6, 7, 8, 9 and 11 respectively form, in each case with a fixed wheel mounted on a countershaft, a wheel plane R2 to R6. A first wheel plane R1 is formed by the planetary stage PG and a seventh wheel plane R7 is formed by the range group GP. The first sub-transmission of the main transmission HG is formed by the wheel planes R4 and R5, and the direct gear too, formed by the shifting element F, is associated with the first sub-transmission of the main transmission HG. The second sub-transmission of the main transmission HG is formed by the wheel planes R2 and R3. The sixth wheel plane R6 forms a drive output constant that can be used by both sub-transmissions.

Only the upper half of the gearset symmetrical to the axis of the shafts 1, 10 and 2 is shown. A mirror-image relative to that axis produces a variant with two countershafts, which serve for power-splitting. However, the gearset is functionally identical in the embodiment variant with only one countershaft 5.

With the transmission a starting function known as EDA, electro-dynamic starting, can be implemented. In this, the electric machine EM can be used on its own or only for assisting the internal combustion engine for starting and accelerating. In a purely electric start, a high starting torque can be provided by way of the planetary stage PG that acts as a constant gear ratio. To be able to start electro-dynamically, the shifting element I must be closed. When the shifting element I is closed, the transmission is in its EDA mode. Furthermore a gear of the second sub-transmission of the main transmission HG, which is associated with the second driveshaft 4, must be engaged and the first sub-transmission of the main transmission HG must be shifted to neutral so that it does not transmit any torque. The first gear of the transmission is associated with the second wheel plane R2. Thus, for electro-dynamic starting the shifting element A or B can be used and for the rest of the power flow the shifting element G and the shifting element L can be closed for the first gear. Thus, in the first gear a power flow is provided from the second driveshaft 4, via the second wheel plane R2, the countershaft 5, the drive output constant R6, the main shaft 10 and the range group GP in the slow range. When the vehicle is at rest the internal combustion engine rotates, for example, at its idling speed and the electric machine EM rotates backward, so that the carrier of the planetary stage PG does not move. The torque ratios at the planetary stage PG are constant. The torque of the internal combustion engine and the torque of the electric machine EM are combined additively at the carrier of the planetary stage PG. During electro-dynamic starting the rotational speed of the electric machine changes until block rotation occurs in the planetary stage PG. Starting can be terminated by closing another shifting element, the shifting element C, D, E or F, and so blocking the planetary stage PG.

If the transmission is operated in the EDA mode, an electro-dynamic shift (EDS) is possible as a powershift function. In this case the shifting element I remains closed in the EDA mode. A gear associated with the second sub-transmission of the main transmission HG and hence with the second driveshaft 4 must be engaged. This serves as a supporting gear by way of which the power flow passes during the powershift. The supporting gear can be identical to the gear currently engaged or to a target gear. However, another gear of the first sub-transmission of the main transmission HG can also be used. The shifting process begins with a load uptake phase during which at the internal combustion engine and at the electric machine EM the torque is adjusted in such manner that it corresponds to the stationary gear ratio of the planetary stage PG. In that way there is still only one power flow through the carrier of the planetary stage PG and the supporting gear. All the other shifting elements are free from load. The shifting elements of the current gear that have become load-free are disengaged. The rotational speeds of the internal combustion engine and the electric machine EM are regulated in such manner that the shifting element of the target gear to be engaged is synchronized. When synchronization has been achieved the shifting element of the target gear is engaged. This completes the shifting process and the load on the electric machine EM can if necessary be reduced. The EDS shifting method has the advantage that the shifting element of the target gear to be engaged is synchronized by a co-operation of the electric machine EM and the internal combustion engine, wherein the electric machine EM can be regulated very effectively. A further advantage of the EDS shifting method is that a high traction force can be produced since the torques of the internal combustion engine and the electric machine are combined additively at the second planetary gearset, the planetary stage PG.

With the transmission according to the invention a known starter generator function integrated under ISG can likewise be implemented, in which the internal combustion engine can be started and accelerated by the electric machine EM and the electric machine EM can also be used as a generator. In the ISO mode the shifting element J is closed and connects the ring gear 13 of the planetary stage PG to a component fixed on the housing. Purely electric driving is also possible in the ISG mode, wherein the ring gear 13 of the planetary stage PG is locked relative to the housing and the electric machine EM transmits a torque to the carrier of the planetary stage PG.

Thus, when the shifting element I is closed the planetary stage PG can act as a superposition transmission. When the shifting element J is closed, the planetary stage PG acts as a fixed preliminary gear ratio for the electric machine EM.

Thanks to the arrangement of the electric machine EM with the planetary stage PG on the second driveshaft 4, the electric machine EM is associated with the second sub-transmission of the main transmission HG. The first driveshaft 1 is driven by a second drive not shown here, namely an internal combustion engine. Thus, the internal combustion engine is or can be connected to the first sub-transmission. With each sub-transmission are also associated shiftable gears by way of the associated wheel planes R2 to R3. The second wheel plane R2 and the third wheel plane R3 of the main transmission HG are associated with the second driveshaft 4 and hence also with the second sub-transmission of the main transmission HG. Thus, purely electric driving is possible by way of the two gears formed by the two wheel planes R2 and R3. During this an element of the planetary stage PG has to be locked relative to the housing. Then, by virtue of the range group GP four shiftable, purely electric gears are produced. For purely electric driving a separator clutch for the internal combustion engine is needed, since the first driveshaft 1 can be decoupled by the open shifting elements C, D, E and F. The fourth wheel plane R4 and the fifth wheel plane R5 of the main transmission HG are associated with the first driveshaft 1 and hence also with the first sub-transmission of the main transmission HG. The sixth wheel plane R6 serves as a drive output constant for both sub-transmissions of the main transmission HG. By virtue of the sub-transmission coupling via the shifting element C, the internal combustion engine and the electric machine EM can use the gears of the respective other sub-transmission of the main transmission HG in spite of that.

Thanks to the two sub-transmissions the internal combustion engine and the electric machine EM can be operated with different gear ratios. Thus, for the internal combustion engine and for the electric machine EM suitable driving-situation-dependent operating points can be selected. Thanks to the sub-transmission coupling by means of the second shifting element C, the internal combustion engine can be connected to the electric machine EM without a torque being passed to the drive output shaft. In that case at least the shifting elements A, B and E, F of the main transmission HG are not actuated, but kept in a neutral position. Thus, the internal combustion engine can be started by the electric machine EM, or in neutral, i.e. independently of the speed of the vehicle, and so even at rest current can be produced.

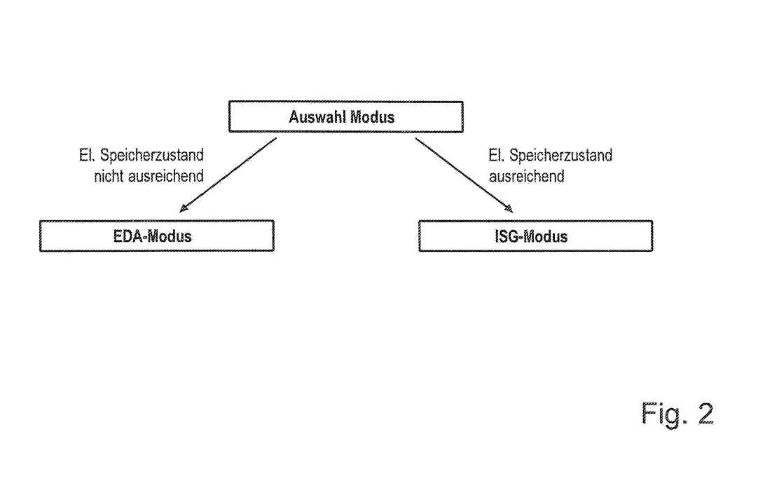

Depending on the condition of the electrical energy storage device, staffing is possible in the ISG mode or in the EDA mode as the starting mode. This is shown in FIG. 2. The ISG mode is mainly chosen when the energy stored in the storage device A is sufficient for the planned starting process. The EDA mode is chosen mainly when there is not sufficient energy in the storage device for the planned starting process. In this context, for this evaluation forecasts about the driving route and the loading situation can be taken into account.

In a next step a starting gear is selected. The starting modes do not necessarily need the first gear to be the starting gear. Depending on the driving resistance or the loading situation, another starting gear may be appropriate.

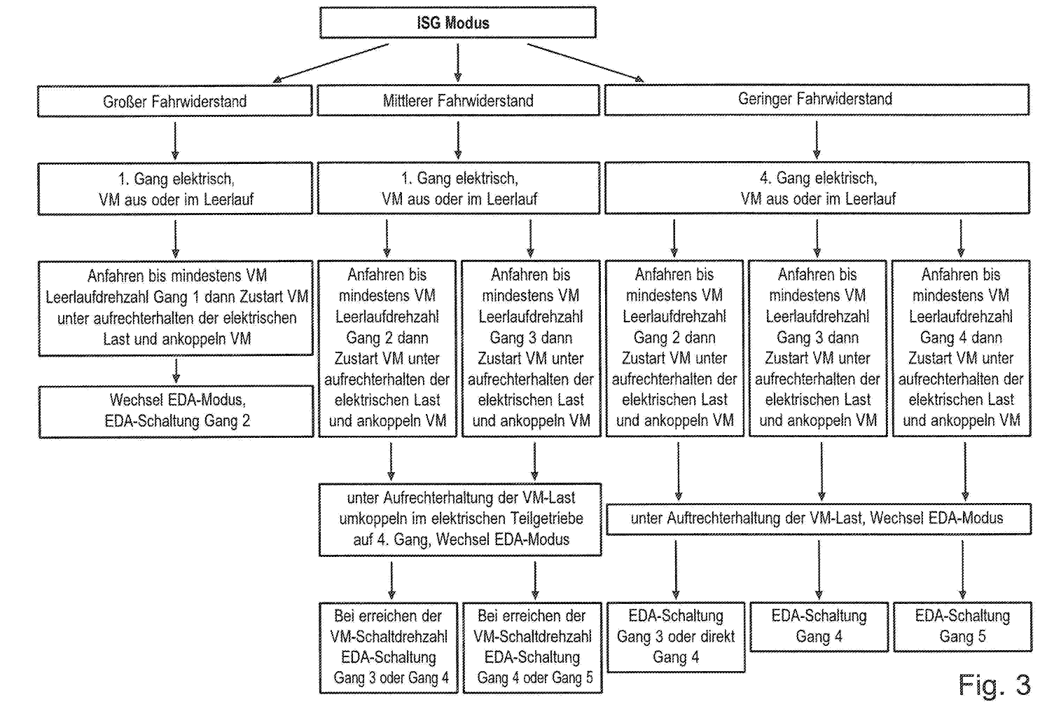

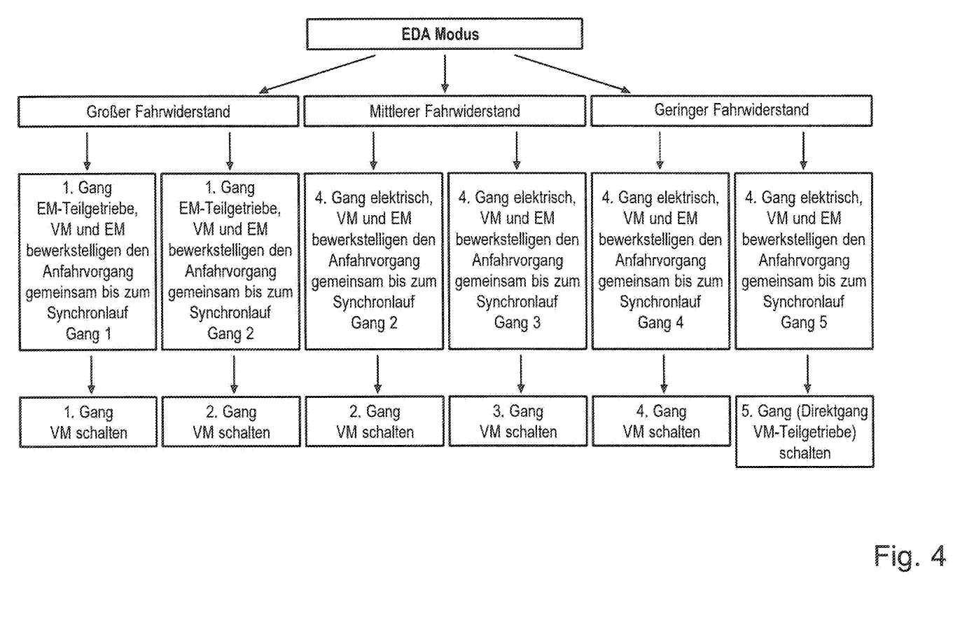

Below, starting strategies according to the invention are described and shown in FIGS. 3 and 4: after evaluating, forecasting and determination or calculation of the storage device condition the driving resistance recognition determines the decision about the choice between the EDA or ISG starting mode. If a sufficient energy level is recognized in the electrical energy storage device starting is carried out purely electrically in the ISG mode. If in parallel a high driving resistance is recognized, the shifting elements J, A, G and L are closed in order to engage the first gear, in which purely electric starting can be carried out. In that case the internal combustion engine can be switched off, or idling. Now, starting takes place in the electric first gear at least until the idling speed of the internal combustion engine has been reached in the first gear. Then the internal combustion engine can be switched on while maintaining the electric load, and coupled in by closing the shifting element C. While maintaining the internal combustion engine load the shifting element J is opened and instead of it the shifting element I is closed. Thereafter, an electro-dynamic shift can be carried out to the second gear by opening the shifting element C and closing the shifting element D.

If a moderate driving resistance is recognized, the shifting elements J, A, G and L are again closed in order to engage the first gear, in which purely electric starting can take place. In this case the internal combustion engine can be switched off, or idling. Then, starting can take place either in the electrical first gear at least until the internal combustion engine idling speed of the second gear is reached, when the internal combustion engine can be switched on while maintaining the electric load, and coupled in by closing the shifting element D. While maintaining the internal combustion engine load the electric sub-transmission is recoupled by opening the shifting element A and closing the shifting element B (wheel plane for the fourth gear). Then, the shifting element J is opened and instead of it the shifting element I is closed. When the internal combustion engine rotational speed of the third or fourth gear has been reached, then either by closing the shifting element E the third gear can be engaged or by opening the shifting element D and closing the shifting element C the fourth gear can be engaged.

Depending on the level of the moderate driving resistance recognized, starting from the first electric starting gear the rotational speed can also be increased until the internal combustion engine idling speed of the third gear has been reached. Then, while maintaining the load the internal combustion engine can be switched on and coupled in by closing the shifting element E. While maintaining the internal combustion engine load the electric sub-transmission can be recoupled by opening the shifting element A and closing the shifting element B (wheel plane for the fourth gear). When the internal combustion engine rotational speed of the fourth or fifth gear is reached, then either the fourth gear can be engaged electro-dynamically by opening the shifting element D and closing the shifting element C, or the fifth gear can be engaged electro-dynamically by opening the shifting element E and closing the shifting element F.

If a low driving resistance is recognized, the shifting elements J, B, G and L are closed in order to engage the fourth gear, in which purely electric starting can take place. The internal combustion engine can be switched off, or idling. Then, in the electric fourth gear starting can take place until at least the internal combustion engine idling rotational speed of the second gear has been reached. Then, while maintaining the electric load, the internal combustion engine can be switched on and coupled in by closing the shifting element D. While maintaining the internal combustion engine load the shifting element J is opened and instead of it the shifting element I is closed. Thereafter, an electro-dynamic shift to the third gear can be carried out by closing the shifting element E, or an electro-dynamic shift to the fourth gear can be carried out directly by opening the shifting element D and closing the shifting element C.

However, after starting in the electric fourth gear, depending on the driving resistance recognized it is also possible to start in the electric fourth gear at least until the internal combustion engine rotational speed of the third gear has been reached. Then, while maintaining the electric load the internal combustion engine can be switched on and coupled in by closing the shifting element E. While maintaining the internal combustion engine load the shifting element J is opened and instead of it the shifting element I is closed. Thereafter, starting can be carried out in the fourth gear by closing the shifting element C.

If there is almost no driving resistance, then after starting in the electric fourth gear one can move off in the electric fourth gear, at least until the internal combustion engine idling speed of the fourth gear is reached. Then, while maintaining the electric load the internal combustion engine can be switched on and coupled in by closing the shifting element C. While maintaining the internal combustion engine load the shifting element J is opened and instead of it the shifting element I is closed. Thereafter, an electro-dynamic shift to the fifth gear can be carried out by closing the shifting element F.

The driving resistance recognition on the basis of evaluation, forecast and storage device condition determines the decision for choosing the EDA starting mode. In this case the control unit recognizes that the energy level in the electrical energy storage device is not sufficient, and accordingly starting is carried out electro-dynamically in the EDA mode. If in parallel a high driving resistance is recognized, the shifting elements I, A, G and L are closed in order to engage the first gear in the electric motor sub-transmission, with which electro-dynamic starting can be carried out. The internal combustion engine and the electric machine carry out the starting process conjointly until synchronization is achieved with the shifting element C. By engaging the shifting element C the first gear is engaged by the internal combustion engine. Depending on the driving situation, starting from the first gear in the electric motor sub-transmission synchronization with the shifting element D can also be achieved. By engaging the shifting element D the second internal combustion engine gear can be engaged.

If in parallel a moderate driving resistance is recognized, the shifting elements I, B, G and L are closed in order to engage the fourth gear in the electric motor sub-transmission, with which electro-dynamic starting can be carried out. The internal combustion engine and the electric machine carry out the starting process conjointly, until synchronization with the shifting element D is achieved. By engaging the shifting element D, the second internal combustion engine gear is engaged. Depending on the driving situation, starting from the fourth gear in the electric motor sub-transmission synchronization with the shifting element E can also be achieved. By engaging the shifting element E, the third internal combustion engine gear can be engaged.

If in parallel a low driving resistance is recognized, the shifting elements I, B, G and L are likewise closed in order to engage the fourth gear in the electric motor sub-transmission, with which electro-dynamic starting can be carried out. The internal combustion engine and the electric machine carry out the starting process conjointly, until synchronization of the shifting element C is achieved. By engaging the shifting element C, the fourth internal combustion engine gear is engaged. Depending on the driving situation, starting from the fourth gear in the electric motor sub-transmission, synchronization of the shifting element F can also be achieved. By engaging the shifting element F, the fifth internal combustion engine gear can be engaged.

In general, the lower the driving resistance in the two modes, the higher can be the starting gear chosen and the follow-up gear selected.

### INDEXES

1 First driveshaft
2 Drive output shaft
3 Sun gear of the planetary stage
4 Second driveshaft
5 Countershaft
6, 7, 8, 9, 11 Loose wheels
10 Main shaft
12 Ring gear of the range group
13 Ring gear of the planetary stage
EM Electric machine
R1 First wheel plane
R2 Second wheel plane
R3 Third wheel plane
R4 Fourth wheel plane
R5 Fifth wheel plane
R6 Sixth wheel plane
R7 Seventh wheel plane
PG Planetary stage
HG Main transmission
GP Range group
A, B, C, D, E, F, G, H Shifting elements of the main group
I, J Shifting elements of the planetary stage
L, S Shifting elements of the range group

1-10. (canceled)

11. A method for starting a motor vehicle having a hybrid drive including an internal combustion engine and an electric machine (EM), the motor vehicle having a transmission arrangement with which starting of the motor vehicle is carried out either electro-dynamically or purely electrically, the method comprising:
evaluating a driving resistance of the motor vehicle and a storage condition of an electrical energy storage device of the electric machine (EM); and
selecting a starting strategy depending on the evaluated driving resistance and the storage condition.

12. The method for starting the motor vehicle having the hybrid drive according to claim 11, further comprising initially choosing a starting mode, when selecting the starting strategy, depending on the storage condition of the electrical energy storage device.

13. The method for starting the motor vehicle having the hybrid drive according to claim 11, further comprising selecting an ISG mode for purely electric starting when energy in the electrical energy storage device is sufficient for a planned starting process.

14. The method for starting the motor vehicle having the hybrid drive according to claim 11, further comprising selecting an EDA mode for electro-dynamic starting if energy in the electrical energy storage device is insufficient for a planned starting process.

15. The method for starting the motor vehicle having the hybrid drive according to claim 12, further comprising, following selection of the starting mode, selecting a starting gear when choosing the starting strategy.

16. The method for starting the motor vehicle having the hybrid drive according to claim 15, further comprising selecting the starting gear depending on the driving resistance.

17. The method for starting the motor vehicle having the hybrid drive according to claim 16, wherein the higher the driving resistance, the lower is the starting gear selected.

18. The method for starting the motor vehicle having the hybrid drive according to claim 15, further comprising selecting the starting gear as a function of a load weight of the motor vehicle.

19. The method for starting the motor vehicle having the hybrid drive according to claim 18, wherein a higher the load weight, the lower is the starting gear selected.

20. A control unit, for operating a drive-train of a motor vehicle with a hybrid drive, which includes an internal combustion engine, an electric machine (EM), and a transmission arrangement, the control unit comprising means for carrying out a method of starting the motor vehicle either electro-dynamically or purely electrically, the method including evaluating a driving resistance of the motor vehicle and a storage condition of an electrical energy storage device of the electric machine (EM), and selecting a starting strategy depending on the evaluated driving resistance and the storage condition.

21. A method for starting a motor vehicle having a hybrid drive comprising an internal combustion engine, an electric machine (EM) and a transmission arrangement, the method comprising:
determining, with a transmission control unit, an electrical charge condition of an electrical energy storage device;
determining, with the transmission control unit, a driving resistance of the motor vehicle:
selecting, with the transmission control unit, one of an electro-dynamic starting mode and a purely electrical starting mode for starting the motor vehicle based on the determined electrical charge condition of the electrical energy storage device;
selecting, with the transmission control unit, a starting gear based on the determined driving resistance of the motor vehicle, following selection of either the electro-dynamic starting mode or the purely electrical starting mode; and
starting the motor vehicle in the selected one of the electro-dynamic starting mode and the purely electrical starting mode and the selected starting gear.
